(19) United States
(12) Patent Application Publication
(10) Pub. No.: US 2006/0037549 A1
(43) Pub. Date: Feb. 23, 2006

(54) Toilet for pet

(76) Inventor: Chang-Sub Kim, Busan (KR)

Correspondence Address: ST. ONGE STEWARD JOHNSTON & REENS, LLC, 986 BEDFORD STREET, STAMFORD, CT, 06905-5619, US

(21) Appl. No.: 11/203,385

(22) Filed: Aug. 12, 2005

Related U.S. Application Data
(63) Continuation of application No. PCT/KR04/00161, filed on Jan. 27, 2004.

(30) Foreign Application Priority Data
Feb. 12, 2003 (KR) 2003-0004122

(51) Int. Cl. A01K 29/00

(52) U.S. Cl. 119/166

(57) ABSTRACT

Disclosed is a toilet for pet, which can treat urine and feces of the pet very cleanly. The toilet for pet includes: a frame having a container, a seating jaw formed on the upper part thereof, and concave parts formed on both sides of the seating jaw; a grating seated on the seating jaw of the frame, the grating having grips formed on both sides and drain holes formed therein; and supporting legs formed on the lower surface of the grating. A user can rapidly collect urine of the pet into the container and rapidly collect and remove feces of the pet by separating the grating from the frame in a state in which feces of the pet is put on the upper part of the grating and by cleaning the grating. Therefore, a user can treat urine and feces of the pet very conveniently and is very sanitary.

This application is a continuation of International Patent Application No. PCT/KR2004/000161 filed Jan. 27, 2004, which designates the United States and claims priority of Korean Patent Application No. 2003-0004122 filed Feb. 12, 2003.

### FIELD OF THE INVENTION

The present invention relates to a toilet for pet, and more particularly, to a toilet for pet, which can treat urine and feces of the pet very cleanly.

### BACKGROUND OF THE INVENTION

In general, a pet grows in a house relieve nature at a specific place (or a specific toilet for pet) as being trained to relieve nature at the specific place.

However, the conventional toilet for pet, in which a simple plate, a container, new paper, sands, or a pad is located at a specific position, is very unsanitary, as the pet makes the circumferences of the toilet dirty by walking about in a state in which urine and feces are stained on the sole of the feet or other parts of the pet after the urination and defecation.

Furthermore, the conventional toilet for pet has another disadvantage in that it is very difficult to collect and treat the urine and feces of the pet.

### DISCLOSURE OF INVENTION

Accordingly, the present invention is directed to a toilet for pet that substantially obviates one or more problems due to limitations and disadvantages of the related art.

An object of the present invention is to provide a toilet for pet, which can allow a user to treat urine and feces of the pet very conveniently, and which is very sanitary.

To achieve these objects and other advantages and in accordance with the purpose of the invention, as embodied and broadly described herein, the toilet for pet includes a frame having a container and a grating seated on the container at a predetermined interval from the bottom surface of the inside of the container, such that a user can rapidly collect urine of the pet into the container and rapidly collect and remove feces of the pet by separating the grating from the frame in a state in which feces of the pet is put on the upper part of the grating and by cleaning the grating. Therefore, the present invention allows a user to treat urine and feces of the pet very conveniently and is very sanitary.

### BRIEF DESCRIPTION OF DRAWINGS

Further objects and advantages of the invention can be more fully understood from the following detailed description taken in conjunction with the accompanying drawings in which:

FIG. 1 is a perspective view of a toilet for pet according to a preferred embodiment of the present invention;

FIG. 2 is an exploded perspective view of the present invention;

FIG. 3 is a plan view of the present invention; and

FIG. 4 is a sectional view showing a used condition of the present invention.

### DETAILED DESCRIPTION OF PREFERRED EMBODIMENTS

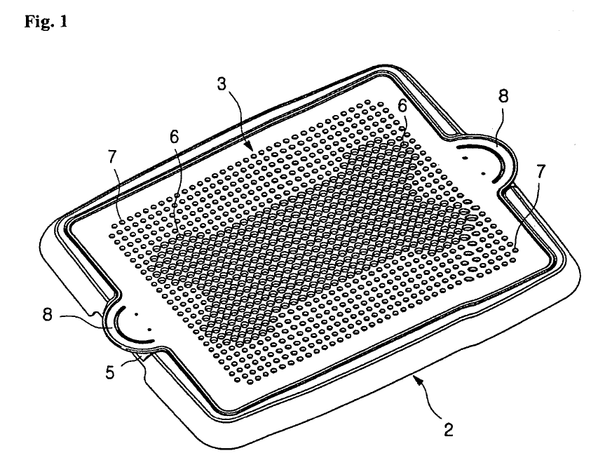

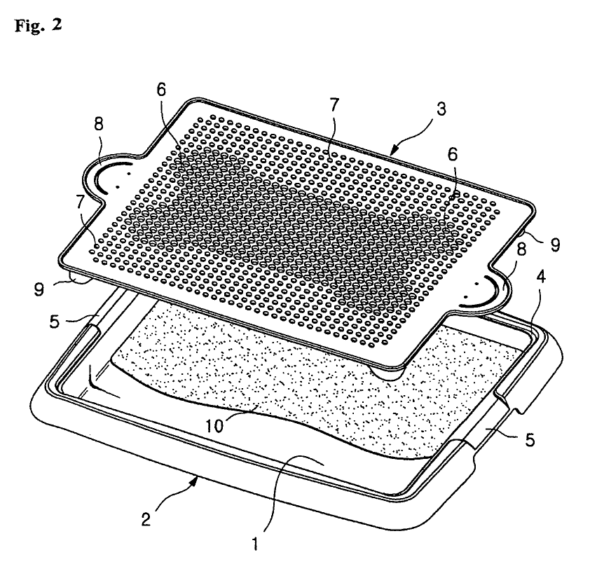

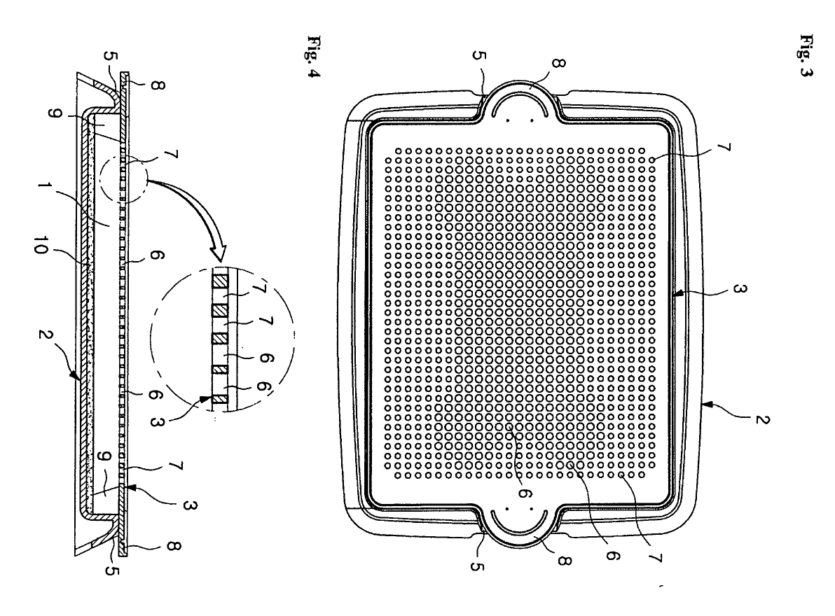

FIG. 1 is a perspective view of a toilet for pet A according to a preferred embodiment of the present invention, FIG. 2 is an exploded perspective view, FIG. 3 is a plan view, and FIG. 4 is a sectional view showing a used condition of the present invention. The present invention will now be described in detail in connection with preferred embodiments with reference to the accompanying drawings.

The toilet A for pet includes: a rectangular frame 2 made of synthetic resin material, anticorrosive stainless material, or other various materials and having a container 1; and a grating 3 seated on the upper part of the container 1 of the frame 2 at a predetermined interval from the floor of the container 1.

The container 1 has a seating jaw 4 formed integrally with the container 1 along the circumference of the upper part of inner wall thereof, and concave parts 5 formed in the right and left side walls for allowing a user to put the user's hands in the container 1 when seating and separating the grating 3.

The grating 3 can have one of various shapes, but in the drawings, the grating 3 has large and small sized drain holes 6 and 7 therein, wherein the large-sized drain holes 6 are formed and arranged in the central part in the shape of a bone to increase design efficiency.

The grating 3 further has grips formed on the right and left sides thereof, and supporting legs 9 formed at four edges of the lower surface thereof, such that the grating 3 can be seated on the container 1 more stably by the seating jaw 4 of the container and the supporting legs 9 of the grating 3.

In the drawings, unexplained reference numeral 10 designates a pad, sands, new paper, or the like, which can be contained in the inside of the container 1.

The toilet A for pet according to the present invention is always located at a place where the pet relieves nature, and allows the user to rapidly collect and remove urine and feces of the pet with ease. A use method of the toilet A for pet will be described in more detail as follows.

The container 1 contains a pad, sands, or new paper 10 therein, and the grating 3 is seated on the container 1 at a predetermined interval from the container 1 by the seating jaw 4 of the container 1 and the supporting legs 9 of the grating 3.

In this condition, when a pet relieves nature, urine is drained rapidly through the large and small sized drain holes 6 and 7 densely formed in the grating 3, and then drops to the pad, the sands, or the new paper 10 contained in the container 1. Therefore, the toilet for pet can minimize staining of urine on the feet of the pet as urine is almost never left over on the upper part of the grating 3.

In addition, when the pet relieves the feces, the user separates the grating 3 from the frame 2 by using the right and left grips 8 of the grating 3, collects and removes the feces into a toilet of a bathroom, and then, cleans the upper part of the grating 3, which is stained with the feces, with cleaning water and a cleaning brush, and thereby, the feces can be treated conveniently.

Moreover, the inside of the container 1 can be cleaned conveniently if the user replaces the pad, the sands, or the new paper 10, which are contained in the inside of the container 1, and, into which urine is soaked, with new one.

### INDUSTRIAL APPLICABILITY

As described above, the toilet A for pet according to the present invention includes the frame 2 having the container 1 and the grating 3 seated on the container 1 at the predetermined interval from the bottom surface of the inside of the container 1, such that the user can rapidly collect urine of the pet into the container 1 and rapidly collect and remove feces of the pet by separating the grating 3 from the frame 2 in a state in which feces of the pet is put on the upper part of the grating 3 and by cleaning the grating 3. Therefore, the present invention allows a user to treat urine and feces of the pet very conveniently and is very sanitary.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A toilet for pet comprising:
a frame having a container, a seating jaw formed on the upper part thereof, and concave parts formed on both sides of the seating jaw;
a grating seated on the seating jaw of the frame, the grating having grips formed on both sides and large and small sized drain holes formed therein; and
supporting legs formed on the lower surface of the grating.
